(19) United States
(12) Patent Application Publication
(10) Pub. No.: US 2025/0084225 A1
(43) Pub. Date: Mar. 13, 2025

(54) HEAT-SHRINKABLE POLYESTER FILM

(71) Applicants: C.I. TAKIRON Corporation, Osaka (JP); Bonset America Corporation, Browns Summit, NC (US)

(72) Inventors: Takuma KANEKO, Osaka (JP); Yuichiro KANZAKA, Osaka (JP); Shuuta YUGE, Osaka (JP); Tatsuya IRIFUNE, Osaka (JP)

(21) Appl. No.: 18/725,969

(22) PCT Filed: Sep. 28, 2022
(86) PCT No.: PCT/JP2022/036186

§ 371 Date: Jul. 1, 2024

(30) Foreign Application Priority Data
Mar. 31, 2022 (JP) 2022-059435

(51) Int. Cl. C08J 5/18; C08J 3/22; C08K 3/36

(52) U.S. Cl. CPC C08J 5/18; C08J 3/226; C08J 2367/06; C08J 2467/06; C08K 3/36; C08K 2201/005

(57) ABSTRACT

A heat-shrinkable polyester film is provided, which has excellent high humidity storage stability, and effectively suppresses a breakage phenomenon of the film at the time of thermal shrinkage. A heat-shrinkable polyester film derived from a polyester resin composition including a crystalline polyester resin of 10% to 70% by weight satisfies the following configurations (a) and (b):
(a) when upper yield point stresses in a stress-strain curve in an MD direction that orthogonally intersects a main shrinkage direction as measured before and after storage for 30 days under high humidity conditions of 23° C. and 50% RH are designated as E1 (MPa) and E2 (MPa), respectively, the E2 and E1 satisfy the following relational expression (1):

$$0 \leq E 2 - E 1 \leq 10 \qquad ( 1 )$$

(b) a thermal shrinkage ratio A1 (main shrinkage direction at 98° C. for 10 seconds) has a value of 30 to 80%.

### TECHNICAL FIELD

The present invention relates to a heat-shrinkable polyester film (hereinafter, sometimes called as a polyester-based shrink film, or simply as a shrink film). More particularly, the present invention relates to a heat-shrinkable polyester film that provides desired thermal shrinkage ratios with satisfactory reproducibility at a predetermined temperature even when the heat-shrinkable polyester film has been stored for a long period of time under predetermined high humidity conditions, and also provides excellent breakage prevention property.

### BACKGROUND ART

Conventionally, shrink films have been widely used as base films for labels of PET bottles and the like. Particularly, it is the current situation that heat-shrinkable polyester films are increasing their market share as base films for labels due to their excellent strength, transparency, and the like.

Although a heat-shrinkable polyester film has such excellent characteristics, since a heat-shrinkable polyester film exhibits rapid thermal response when heated, a situation in which the film shrinks non-uniformly and is likely to break, can be seen.

That is, a heat-shrinkable polyester film is affected by the storage conditions for shrink films, particularly humidity and the like, so that the thermal shrinkage ratio at a predetermined temperature as a physical property varies, and furthermore, there is observed a problem that breakage prevention property is likely to be decreased.

Thus, in order to improve breakage prevention property and the like in labels, various heat-shrinkable polyester films suitable for use in labels, which have high thermal shrinkage ratios in the width direction while having low thermal shrinkage ratios in the longitudinal direction, have high mechanical strength in the longitudinal direction, and have satisfactory perforation opening property and excellent shrink finish property, have been proposed (see, for example, Patent Document 1).

More specifically, a biaxially stretched heat-shrinkable polyester film satisfying the following configuration requirements (1) to (6) is available.

(1) 1,4-cyclohexanedimethanol is used as an amorphous monomer in an amount in a range of 5 mol % or more and 30 mol % or less in 100 mol % of the alcohol component.

(2) The hot water thermal shrinkage ratio obtained when the film is immersed in hot water at 98° C. for 10 seconds is 60% or more and 90% or less in the main shrinkage direction of the film.

(3) The hot water thermal shrinkage ratio obtained when the film is immersed in hot water at 98° C. for 10 seconds is-5% or more and 5% or less in a direction orthogonally intersecting the main shrinkage direction of the film.

(4) The right-angle tear strength per unit thickness in the direction orthogonally intersecting the main shrinkage direction after shrinking the film by 10% in the main shrinkage direction in hot water at 80° C. is 180 N/mm or more and 350 N/mm or less.

(5) The maximum shrinkage stress in the main shrinkage direction of the film measured with hot air at 90° C. is 2 MPa or more and 10 MPa or less, and the shrinkage stress after 30 seconds from the start of measurement is 60% or more and 100% or less of the maximum shrinkage stress.

(6) The difference between the hot water thermal shrinkage ratios in the main shrinkage direction at 70° C. measured before and after an aging treatment at a temperature of 30° C., a humidity of 65% RH for 672 hours, is 10% or less.

### CITATION LIST

### Patent Document

Patent Document 1: JP 2019-81378 A (claims and the like)

### DISCLOSURE OF THE INVENTION

### Problem to be Solved by the Invention

However, in the case of the heat-shrinkable polyester film disclosed in Patent Document 1, no consideration has been given to an attempt at producing a heat-shrinkable polyester film containing a crystalline polyester resin, limiting the blending amount and the like of such a crystalline polyester resin to predetermined ranges, and controlling the hygroscopic property and the like in order to reduce variation in the physical properties such as thermal shrinkage ratios.

Furthermore, in the case of such a heat-shrinkable polyester film, an aging treatment is performed under the conditions of 30° C. or lower and 65% RH for 672 hours, and the difference between the hot water thermal shrinkage ratios in the main shrinkage direction at 70° C. measured before and after the aging treatment is controlled to a value of 10% or less; however, since hygroscopic property is not taken into consideration, in reality, stable control of the thermal shrinkage ratio is difficult.

Therefore, the heat-shrinkable polyester film disclosed in Patent Document 1 frequently has a problem that when the heat-shrinkable polyester film is wrapped around a PET bottle as a shrink label and is shrunk, the shrink label is likely to break.

Thus, the inventors of the present invention made extensive efforts in view of the above-described problems, and as a result, the inventors solved the problems in the related art by providing a heat-shrinkable polyester film derived from a polyester resin composition including a predetermined amount of a crystalline polyester resin, which has at least predetermined configurations (a) and (b).

That is, it is an object of the present invention to provide a heat-shrinkable polyester film that provides desired thermal shrinkage ratios with satisfactory reproducibility at a predetermined temperature even when the heat-shrinkable polyester film has been stored for a long period of time under high humidity conditions, and also has excellent breakage prevention property.

### Means for Solving Problem

According to the present invention, there is provided a heat-shrinkable polyester film derived from a polyester resin composition including a crystalline polyester resin in an amount in a range of 10% to 70% by weight with respect to a total resin amount, in which a main shrinkage direction is designated as TD direction, a direction orthogonally intersecting the TD direction is designated as MD direction, and the heat-shrinkable polyester film satisfies the following configurations (a) and (b), and the above-mentioned problems can be solved.

(a) When upper yield point stresses in a stress-strain curve (hereinafter, may be referred to as SS curve) in the MD direction as measured before and after storage for 30 days under high humidity conditions at 23° C. and 50% RH, are designated as E1 (MPa) and E2 (MPa), respectively, the values of E1 and E2 satisfy the following relational expression (1):

$$0 \leq E 2 - E 1 \leq 10 \qquad ( 1 )$$

(b) When a thermal shrinkage ratio in the TD direction in a case where the heat-shrinkable polyester film is shrunk under the conditions of 10 seconds in hot water at 98° C. is designated as A1, the A1 has a value within a range of 30% to 80%.

That is, as a heat-shrinkable polyester film derived from a polyester resin composition including a crystalline polyester resin in an amount in a range of 10% to 70% by weight with respect to the total resin amount satisfies the configurations (a) and (b), the heat-shrinkable polyester film can have little changes in the physical properties while having satisfactory thermal shrinkage ratios even in a case where the film has been stored for a long period of time under high humidity conditions, and can exhibit satisfactory breakage prevention property.

The breakage prevention property can be determined, for example, according to the evaluation criteria in Evaluation 7 in Example 1.

Upon configuring the heat-shrinkable polyester film of the present invention, as configuration (c), it is preferable that the upper yield point stress E1 has a value within a range of 45 to 65 MPa, and the upper yield point stress E2 has a value within a range of 50 to 70 MPa.

By specifically limiting the values of the upper yield point stresses E1 and E2 in the SS curve in this way, for example, even in a case where the heat-shrinkable polyester film has been subjected to long-term storage for 30 days or more under high humidity conditions at 50% RH or higher, the shrink film has even less changes in the physical properties and can exhibit satisfactory and stable breakage prevention property.

Upon configuring the heat-shrinkable polyester film of the present invention, as configuration (d), when lower yield point stresses in a stress-strain curve in the MD direction as measured before and after storage for 30 days under high humidity conditions at 23° C. and 50% RH are designated as E3 (MPa) and E4 (MPa), respectively, it is preferable that the E3 and E4 satisfy the following relational expression (2):

$$0 \leq E 4 - E 3 \leq 8 \qquad ( 2 )$$

By limiting a numerical value represented by E4-E3 to a value within a predetermined range in this way, even in a case where the heat-shrinkable polyester film has been stored for a long period of time under high humidity conditions, the shrink film has little changes in the physical properties and can stably exhibit satisfactory breakage prevention property.

Upon configuring the heat-shrinkable polyester film of the present invention, as configuration (e), it is preferable that the lower yield point stress E3 has a value within a range of 20 to 35 MPa, and the lower yield point stress E4 has a value within a range of 20 to 35 MPa.

By specifically limiting the values of the lower yield point stresses E3 and E4 in the SS curve in this way, even in a case where the heat-shrinkable polyester film has been stored for a long period of time under high humidity conditions, the shrink film has even less changes in the physical properties, can exhibit satisfactory and stable breakage prevention property, and can control the breakage prevention property as a specific numerical value.

Upon configuring the heat-shrinkable polyester film of the present invention, as configuration (f), when a thermal shrinkage ratio in the TD direction in a case where the heat-shrinkable polyester film is shrunk under the conditions of 10 seconds in hot water at 80° C. is designated as A2, it is preferable that the A2 has a value within a range of 15% to 60%.

By limiting the thermal shrinkage ratio A2 measured under predetermined conditions to a predetermined range, the thermal shrinkage ratio A1 can be controlled to a value within a predetermined range, and satisfactory and stable breakage prevention property can be exhibited.

Upon configuring the heat-shrinkable polyester film of the present invention, as configuration (g), when a thermal shrinkage ratio in the TD direction in a case where the heat-shrinkable polyester film is shrunk under the conditions of 10 seconds in hot water at 70° C. is designated as A3, it is preferable that the A3 has a value of 20% or less.

By specifically limiting the thermal shrinkage ratio A3 measured under predetermined conditions to be equal to or less than a predetermined value in this way, the thermal shrinkage ratio at 80° C. to 100° C. can be controlled to a value within a predetermined range, and satisfactory and stable breakage prevention property can be exhibited.

Upon configuring the heat-shrinkable polyester film of the present invention, as configuration (h), it is preferable that b* in the chromaticity coordinates of CIE 1976 L*a*b* (hereinafter, may be simply referred to as CIE chromaticity coordinates) as measured according to JIS Z 8781-4:2013 has a value within a range of 0.15 to 0.5.

By limiting b* in the CIE chromaticity coordinates to a value within a predetermined range in this way, not only the heat-shrinkable polyester film has excellent transparency feeling but also the blending amount of the crystalline polyester resin and the like can be controlled more accurately to a desired range, though indirectly.

Upon configuring the heat-shrinkable polyester film of the present invention, as configuration (j), it is preferable that a haze value of the film before thermal shrinkage as measured according to JIS K 7136:2000 has a value of 8% or less.

By specifically limiting the haze value to a value within a predetermined range in this way, the transparency of the heat-shrinkable polyester film is also easily controlled quantitatively, and since the transparency is satisfactory, versatility can be further enhanced.

### BRIEF DESCRIPTION OF DRAWINGS

FIGS. 1A to 1C are each a diagram for describing a form of a heat-shrinkable polyester film;

FIG. 2 is a diagram for describing the relationship between the blending amount of a crystalline polyester resin in the heat-shrinkable polyester film and the value of b* in the CIE chromaticity coordinates;

FIGS. 3A and 3B are diagrams for describing the relationship between the blending amount of the crystalline polyester resin in the heat-shrinkable polyester film and the difference between upper yield point stresses (E2-E1) measured before and after an aging treatment, and the relationship between the blending amount of the crystalline polyester resin and the difference between lower yield point stresses (E4-E3) measured before and after an aging treatment;

FIG. 4 is a diagram for describing the relationship between the blending amount of the crystalline polyester resin in the heat-shrinkable polyester film and the number of broken test pieces (pieces/5 pieces) in the evaluation of breakage prevention property;

FIG. 5 is a diagram for describing the upper yield point stresses E1 and E2 measured before and after an aging treatment, and the lower yield point stresses E3 and E4 measured before and after an aging treatment;

FIG. 6 is a diagram for describing the relationship between the difference between the upper yield point stresses E1 and E2 (E2-E1) measured before and after an aging treatment and the number of broken test pieces (pieces/5 pieces) in the evaluation of the breakage prevention property;

FIG. 7A is a diagram (photograph) showing the state of a test piece corresponding to Example 1 in a case where breakage does not occur, and FIG. 7B is a diagram (photograph) showing the state of a test piece corresponding to Comparative Example 1 in a case where breakage has occurred; and

FIG. 8 is a diagram for describing the relationship between the difference between the lower yield point stresses E3 and E4 (E4-E3) measured before and after an aging treatment and the number of broken test pieces (pieces/5 pieces) in the evaluation of the breakage prevention property.

### BEST MODES FOR CARRYING OUT THE INVENTION

### First Embodiment

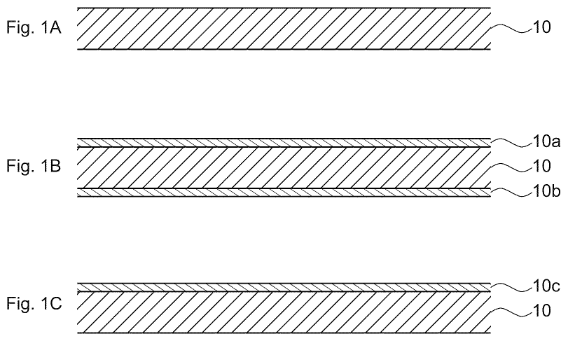

A first embodiment is, as illustrated in FIGS. 1A to 1C, a heat-shrinkable polyester film 10 derived from a polyester resin composition including a crystalline polyester resin in an amount in a range of 10% to 70% by weight with respect to the total resin amount, in which a main shrinkage direction is designated as TD direction, and a direction orthogonally intersecting the TD direction is designated as MD direction, the heat-shrinkable polyester film satisfies the following configurations (a) and (b):

(a) when the upper yield point stresses in a stress-strain curve in the MD direction as measured before and after storage for 30 days under high humidity conditions at 23° C. and 50% RH are designated as E1 (MPa) and E2 (MPa), respectively, the E1 and E2 satisfy the following relational expression (1):

$$0 \leq E 2 - E 1 \leq 10 ; \qquad ( 1 )$$

(b) when a thermal shrinkage ratio in the TD direction in a case where the heat-shrinkable polyester film is shrunk under the conditions of 10 seconds in hot water at 98° C. is designated as A1, the A1 has a value within a range of 30% to 80%.

Hereinafter, various parameters and the like will be specifically described by dividing the configuration of the heat-shrinkable polyester film of the first embodiment, with appropriate reference to the drawings.

### 1. Polyester Resin

Regarding a polyester resin, which is a main component, the type thereof is basically not limited as long as it is a polyester resin that is likely to satisfy the above-mentioned relational expression (1); however, usually, it is preferable that the polyester resin is a polyester resin composed of a diol and a dicarboxylic acid, a polyester resin composed of a diol and a hydroxycarboxylic acid, a polyester resin composed of a diol, a dicarboxylic acid, and a hydroxycarboxylic acid, or a mixture of these polyester resins.

Here, the diol as a compound component of the polyester resin may be at least one of aliphatic diols such as ethylene glycol, diethylene glycol, propanediol, butanediol, neopentyl glycol, and hexanediol; alicyclic diols such as 1, 4-hexanedimethanol; and aromatic diols.

Among these, ethylene glycol, diethylene glycol, and 1, 4-hexanedimethanol are particularly preferred.

The dicarboxylic acid as a compound component of the same polyester resin may be at least one of fatty acid dicarboxylic acids such as adipic acid, sebacic acid, and azelaic acid; aromatic dicarboxylic acids such as terephthalic acid, naphthalenedicarboxylic acid, and isophthalic acid; alicyclic dicarboxylic acids such as 1,4-cyclohexanedicarboxylic acid; or ester-forming derivatives of these.

Among these, terephthalic acid is particularly preferred.

The hydroxycarboxylic acid as a compound component of the same polyester resin may be at least one of lactic acid, hydroxybutyric acid, and polycaprolactone.

As a non-crystalline polyester resin, for example, a non-crystalline polyester resin composed of dicarboxylic acids including at least 80 mol % of terephthalic acid, and diols composed of 50 mol % to 80 mol % of ethylene glycol and 20 mol % to 50 mol % of one or more selected from 1,4-cyclohexanedimethanol, neopentyl glycol, and diethylene glycol, can be suitably used.

In order to change the property of the film as needed, other dicarboxylic acids and diols or hydroxycarboxylic acids may also be used. Each of these components may be used singly or as a mixture.

On the other hand, examples of the crystalline polyester resin include polyethylene terephthalate, polyethylene naphthalate, polybutylene terephthalate, polybutylene naphthalate, and polypropylene terephthalate, and each of these may be used singly or as a mixture.

Furthermore, when the polyester resin is a mixture of a crystalline polyester resin and a non-crystalline polyester resin, in order to obtain satisfactory and appropriate breakage prevention property, heat resistance, thermal shrinkage ratio, and the like, it is preferable that the blending amount of the crystalline polyester resin has a value within a range of 10% to 70% by weight with respect to the total amount (100% by weight) of the resins constituting the heat-shrinkable polyester film.

The reason for this is that by specifically limiting the content of the crystalline polyester resin in this way, the heat shrinkage ratio near the shrinkage temperature and the breakage prevention property can be adjusted more easily to desired ranges, and at the same time, the haze value related to transparency and the like are also easily controlled quantitatively.

More specifically, it is because when the content of the crystalline polyester resin has a value of less than 10% by weight, it may be difficult to control the breakage prevention property of the heat-shrinkable polyester film.

Furthermore, it is because when the content of the crystalline polyester resin is more than 70% by weight, not only sufficient thermal shrinkage ratios may not be obtained at a predetermined shrinkage temperature, but also the ranges in which predetermined factors influencing the breakage prevention property, the haze value, and the like can be controlled may be markedly narrowed.

Therefore, it is more preferable that the blending amount of the crystalline polyester resin has a value within a range of 20% to 60% by weight, and even more preferably a value within a range of 30% to 50% by weight, with respect to the total amount (100% by weight) of resins.

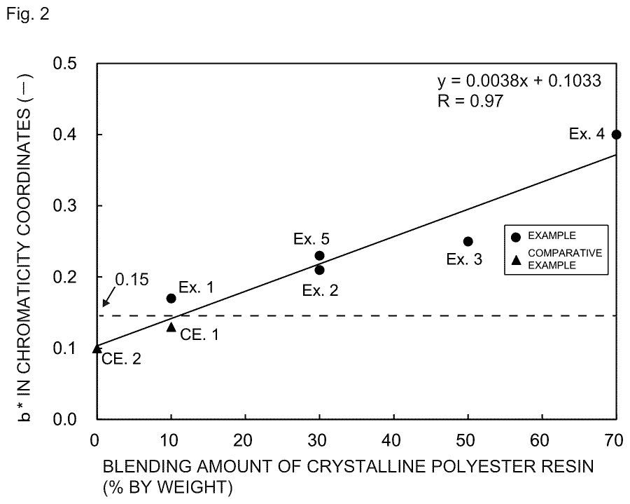

Here, referring to FIG. 2, the relationship between the blending amount of the crystalline polyester resin in the heat-shrinkable polyester film and the value of b* in the chromaticity coordinates of CIE 1976 L*a*b* as measured according to JIS Z 8781-4:2013 will be described.

That is, the axis of abscissa in FIG. 2 represents, for example, the blending amount (% by weight) of the crystalline polyester resin in a heat-shrinkable polyester film having a thickness of 30 μm, and the axis of ordinate represents the value of b* (−) in the CIE chromaticity coordinates.

In the diagram, Example 1 is described as Ex. 1, while Comparative Example 1 is described as CE. 1, and the same applies hereinafter.

From the characteristic curve in FIG. 2, it is understood that there is an excellent correlation (correlation coefficient (R) is 0.97) in the relationship between the blending amount of such a crystalline polyester resin and the value of b* in the CIE chromaticity coordinates.

Therefore, it can be said that by limiting the blending amount of the crystalline polyester resin, the value of b* in the CIE chromaticity coordinates is also easily controlled to be within a predetermined range.

Conversely, it is understood that by limiting b* in the CIE chromaticity coordinates to a value within a predetermined range (0.15 to 0.5), the blending amount of the crystalline polyester resin and the like in the heat-shrinkable polyester film can be controlled more accurately, though indirectly.

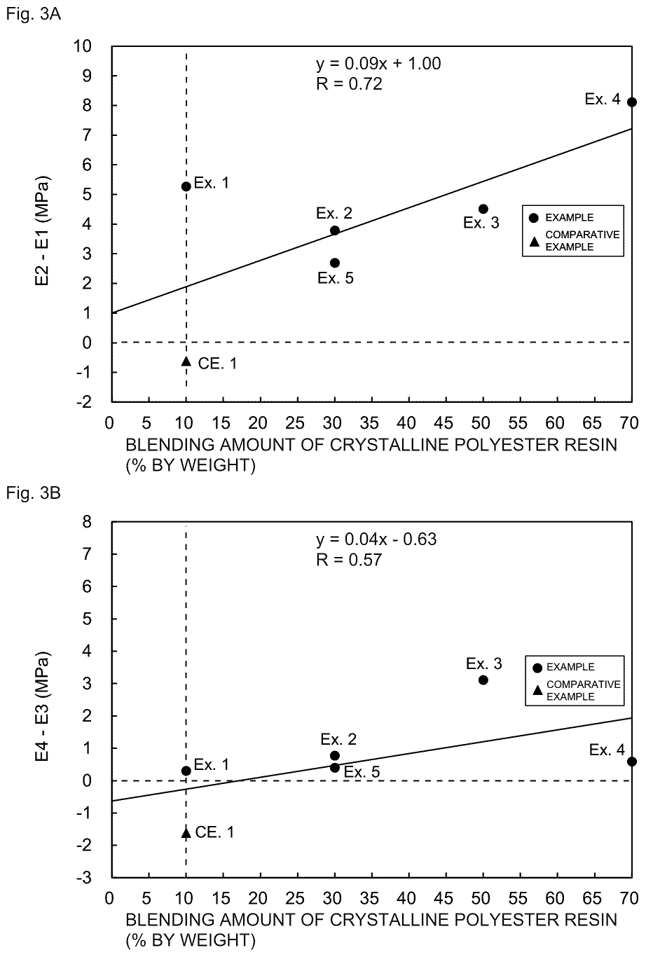

Next, referring to FIG. 3A, the relationship between the blending amount of the crystalline polyester resin in the heat-shrinkable polyester film and the difference between the upper yield point stresses (E2−E1) in the SS curve measured before and after an aging treatment of the heat-shrinkable polyester film, will be described.

That is, the axis of abscissa in FIG. 3A represents the blending amount (% by weight) of the crystalline polyester resin, and the axis of ordinate represents the value of E2−E1 (MPa), which is the difference between the upper yield point stresses in the SS curve.

From the characteristic curve in FIG. 3A, as the blending amount of the crystalline polyester resin increases, the numerical value represented by E2−E1 tends to increase.

Therefore, it can be said that by limiting the blending amount of the crystalline polyester resin, the numerical value represented by E2−E1 is also easily controlled to be within a predetermined range.

Next, referring to FIG. 3B, the relationship between the blending amount of the crystalline polyester resin in the heat-shrinkable polyester film and the difference between the lower yield point stresses (E4−E3) in the SS curve measured before and after an aging treatment of the heat-shrinkable polyester film, will be described.

That is, the axis of abscissa in FIG. 3B represents the blending amount (% by weight) of the crystalline polyester resin, and the axis of ordinate represents the value of E4−E3 (MPa), which is the difference between the lower yield point stresses in the SS curve.

From the characteristic curve in FIG. 3B, as the blending amount of the crystalline polyester resin increases, the numerical value represented by E4−E3 tends to increase.

Therefore, it can be said that by limiting the blending amount of the crystalline polyester resin, the numerical value represented by E4−E3 is also easily controlled to be within a predetermined range.

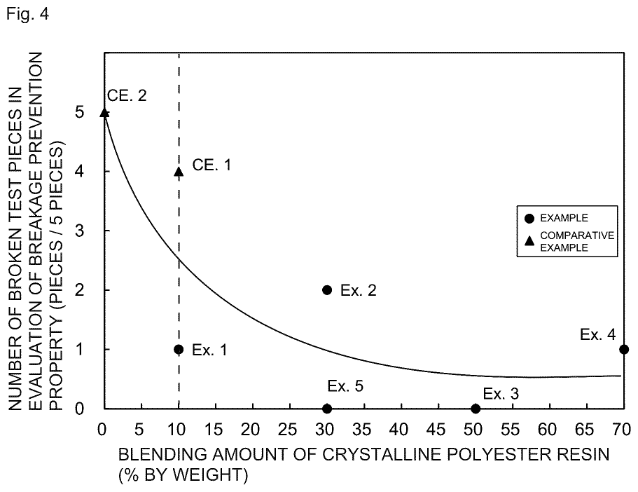

Next, referring to FIG. 4, the relationship between the blending amount of the crystalline polyester resin in the heat-shrinkable polyester film and the number of film breakages in five films when the film elongation is 10% or less (elastic region), will be described.

That is, the axis of abscissa in FIG. 4 represents the blending amount (% by weight) of the crystalline polyester resin, and the axis of ordinate represents the number of broken test pieces (pieces/5 pieces) in the evaluation of breakage prevention property.

From the characteristic curve in FIG. 4, as the blending amount of the crystalline polyester resin increases, the number of broken test pieces tends to decrease.

Therefore, it can be said that by limiting the blending amount of the crystalline polyester resin, the number of broken test pieces can also be controlled to be smaller.

### 2. Configuration (a)

Configuration (a) is a necessary configuration requirement to the effect that with regard to the heat-shrinkable polyester film of the first embodiment, when the upper yield point stresses in a stress-strain curve (SS curve) in the MD direction as measured before and after storage for 30 days under high humidity conditions at 23° C. and 50% RH are designated as E1 (MPa) and E2 (MPa), respectively, the values of E1 and E2 satisfy a predetermined relational expression (1).

The reason for this is that even when the heat-shrinkable polyester film has been stored for a long period of time under predetermined high humidity conditions, changes in the physical properties of the shrink film can be suppressed, and excellent breakage prevention property can be obtained.

More specifically, it is because when the numerical value represented by E2−E1, which is the difference between the upper yield point stresses, has a value of less than 0 MPa, or conversely a value of more than 10 MPa, changes in the physical properties of the film under high humidity conditions cannot be sufficiently suppressed, and not only satisfactory storage stability may not be obtained, but also satisfactory breakage prevention property cannot be exhibited.

Therefore, it is more preferable that the numerical value represented by E2−E1 has a value within a range of 1 to 9 MPa, and even more preferably a value within a range of 2 to 8 MPa.

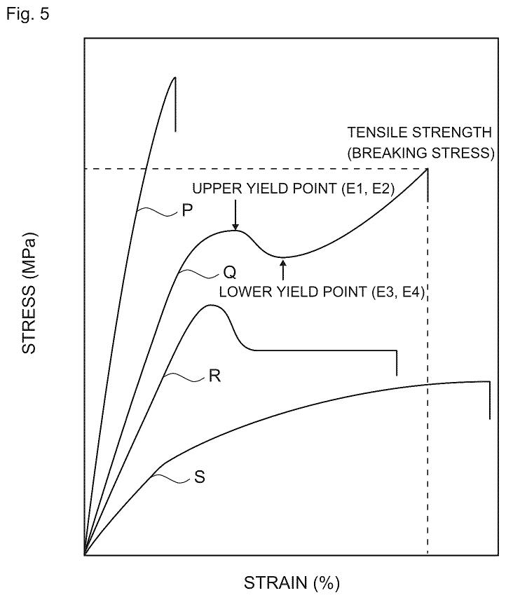

Here, referring to FIG. 5, by using an SS curve in the MD direction of the heat-shrinkable polyester film, the upper yield point stresses E1 and E2 in the MD direction measured before and after an aging treatment of the film under predetermined conditions (storage for 30 days under high humidity conditions at 23° C. and 50% RH), and the lower yield point stresses E3 and E4 in the MD direction measured before and after an aging treatment of the film under predetermined conditions (storage for 30 days under high humidity conditions at 23° C. and 50% RH), will be described.

That is, the axis of abscissa in FIG. 5 represents the value of strain (%) in the MD direction of the heat-shrinkable polyester film, and the axis of ordinate represents the stress (MPa) corresponding to the strain.

Among such characteristic curves P to S in FIG. 5, the heat-shrinkable polyester film of the first embodiment usually corresponds to the characteristic curve Q.

According to the characteristic curve Q, it is understood that when the strain in the MD direction of the heat-shrinkable polyester film is increased, stress occurs correspondingly thereto, and the value of the stress also increases.

Next, when the strain in the MD direction is further increased, crystal transition of the heat-shrinkable polyester film occurs, and an upwardly protruding broad peak appears. This is defined as an upper yield point. Next, when the strain in the MD direction is further increased, crystal transition of the heat-shrinkable polyester film occurs again, and a downwardly protruding broad peak appears. This is defined as a lower yield point.

Next, when the strain in the MD direction is further increased, the value of stress also increases correspondingly thereto, and at a certain strain, breakage of the heat-shrinkable polyester film occurs, and the maximum stress on the SS curve, which is the stress corresponding to this strain, is defined as tensile strength (may also be referred to as breaking stress).

When the characteristic curve of the heat-shrinkable polyester film of the first embodiment is a curve close to the characteristic curve P or S, the tensile strength means breaking stress, and when the characteristic curve of the heat-shrinkable polyester film is a curve close to the characteristic curve R, the tensile strength means the upper yield point stress, which is the stress at the upper yield point.

That is, the present invention is intended to find predetermined relationships between the difference between the upper yield point stresses E1 and E2 (E2−E1) obtained before and after an aging treatment under predetermined conditions and the breakage prevention property and the like, and to control the breakage prevention property and the like.

In addition, the present invention is intended to find predetermined relationships between the difference between the lower yield point stresses E3 and E4 (E4−E3) obtained before and after an aging treatment under predetermined conditions and the breakage prevention property and the like, and to control the breakage prevention property and the like.

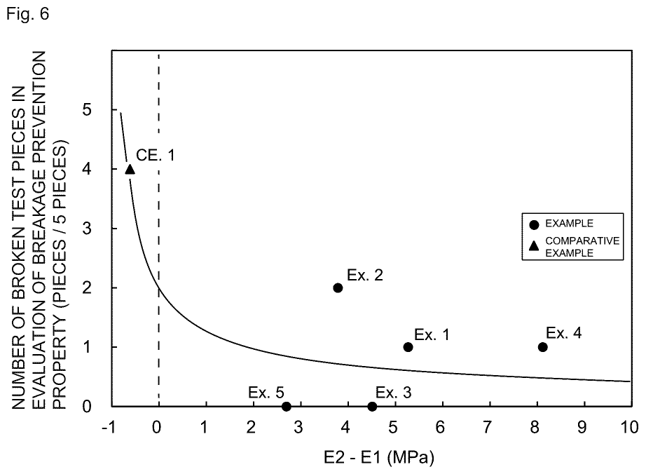

Next, referring to FIG. 6, the value of E2−E1 (MPa), which is the difference between the upper yield point stresses E1 and E2 in the SS curve as measured before and after an aging treatment of the heat-shrinkable polyester film under predetermined conditions (storage for 30 days under high humidity conditions at 23° C. and 50% RH), is plotted on the axis of abscissa, while the number of broken test pieces (pieces/5 pieces) in the evaluation of the breakage prevention property is plotted on the axis of ordinate, and the relationship of these will be described.

From such a characteristic curve in FIG. 6, it is understood that when the lower limit of the numerical value represented by E2−E1 is 0 MPa or more, the number of broken test pieces in the evaluation of the breakage prevention property is extremely small, and satisfactory breakage prevention property is exhibited.

In contrast, it is understood that when the numerical value represented by E2−E1 has a value of less than 0 MPa, the number of broken test pieces is notably large, and sufficient breakage prevention property is not exhibited.

When it has been made clear that when the numerical value represented by E2−E1 has a value of more than 10 MPa, the number of broken test pieces hardly changes; however, separately, the value of the obtained thermal shrinkage ratios are markedly decreased.

It has been also separately found that in the evaluation of the breakage prevention property, before the aging treatment, the number of test pieces in which a breakage phenomenon has occurred (pieces/5 pieces) among five test pieces is 0 in all of the films of Examples 1 to 5 and Comparative Examples 1 and 2.

Furthermore, it has been separately found that in the present evaluation of the breakage prevention property, when a heat-shrinkable polyester film exhibiting satisfactory breakage prevention property is produced into a shrink label and is shrunk to be wrapped around a bottle, the label can be wrapped around without breaking.

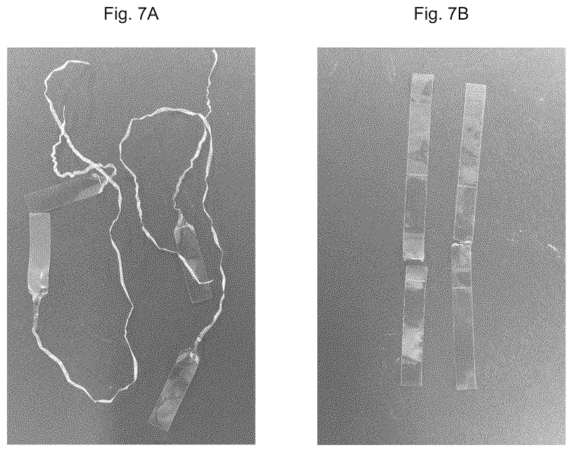

Next, FIG. 7 will be described. That is, FIG. 7A is a diagram (photograph) corresponding to Example 1, which shows the state of a test piece in a case where breakage has not occurred.

More specifically, it is understood that in a tensile test using a test piece cut out from the heat-shrinkage polyester film after an aging treatment under predetermined conditions (storage for 30 days under high humidity conditions at 23° C. and 50% RH), even when the tension site of the test piece was elongated, breakage did not occur.

On the other hand, FIG. 7B is a photograph showing the state of a test piece corresponding to Comparative Example 1, in which breakage has occurred.

More specifically, it is understood that in a tensile test using a test piece cut out from the heat-shrinkable polyester film after an aging treatment under predetermined conditions (storage for 30 days under high humidity conditions at 23° C. and 50% RH), since the pulled site of the test piece was slightly elongated as compared with the case of the test piece in FIG. 7A, breakage occurred.

### 3. Configuration (b)

Configuration (b) is a necessary configuration requirement to the effect that when the thermal shrinkage ratio in the TD direction in a case where the heat-shrinkable polyester film is shrunk under the conditions of 10 seconds in hot water at 98° C. is designated as A1, the A1 has a value within a range of 30% to 80%.

That is, by specifically limiting the thermal shrinkage ratio A1 in hot water at 98° C. for 10 seconds in this way, a stable thermal shrinkage ratio is obtained at 80° C. to 100° C., and furthermore, satisfactory breakage prevention property can be obtained.

Therefore, it is more preferable that the thermal shrinkage ratio A1 has a value within a range of 35% to 75%, and even more preferably a value within a range of 40% to 70%.

The thermal shrinkage ratio of a shrink film is defined by the following formula.

$$Thermal shrinkage ratio ( \% ) = ( {L}_{0} - {L}_{1} ) / {L}_{0} \times 100$$

L₀: Dimension (longitudinal direction or width direction) of a sample before heat treatment
L₁: Dimension (same direction as L₀) of the sample after heat treatment

### 4. Optional Configuration Requirements

### (1) Configuration (c)

Configuration (c) is an optional configuration requirement to the effect that the upper yield point stress E1 before an aging treatment has a value within a range of 45 to 65 MPa, and the upper yield point stress E2 after an aging treatment under predetermined conditions has a value within a range of 50 to 70 MPa.

That is, by specifically limiting the values of the upper yield point stresses E1 and E2 in the SS curve measured before and after an aging treatment, even when the heat-shrinkable polyester film has been stored for a long period of time under high humidity conditions, the hygroscopic property can be controlled.

Therefore, the shrink film has even less changes in the physical properties and can exhibit satisfactory and stable breakage prevention property.

Furthermore, since each of the upper yield point stresses E1 and E2 is controlled as a specific numerical value, the breakage prevention property and the like can be controlled more accurately.

Therefore, it is more preferable that the upper yield point stress E1 has a value within a range of 50 to 60 MPa, and even more preferably a value within a range of 52 to 58 MPa.

It is more preferable that the upper yield point stress E2 has a value within a range of 55 to 65 MPa, and even more preferably a value within a range of 56 to 64 MPa.

### (2) Configuration (d)

Configuration (d) is an optional configuration requirement to the effect that when the lower yield point stresses in the stress-strain curve in the MD direction as measured before and after storage for 30 days under high humidity conditions at 23° C. and 50% RH are designated as E3 (MPa) and E4 (MPa), the E3 and E4 satisfy the following relational expression (2):

$$0 \leq E 4 - E 3 \leq 8 \qquad ( 2 )$$

The reason for this is that by limiting the numerical value represented by E4−E3 to a value within a predetermined range in this way, even when the heat-shrinkable polyester film has been stored for a long period of time under high humidity conditions, the hygroscopic property can be controlled, and the film has little changes in the physical properties and can exhibit satisfactory breakage prevention property.

Therefore, it is more preferable that the numerical value represented by E4−E3 has a value within a range of 1 to 7 MPa, and even more preferably a value within a range of 2 to 6 MPa.

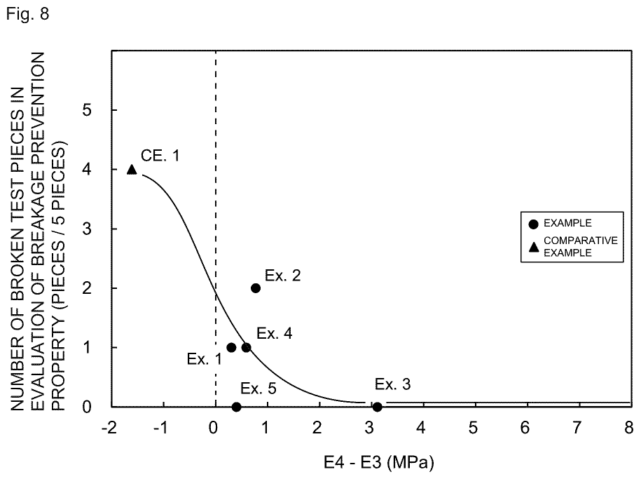

Here, referring to FIG. 8, the value of E4−E3 (MPa), which is the difference between the lower yield point stresses E3 and E4 in the SS curve measured before and after an aging treatment of the heat-shrinkable polyester film under predetermined conditions (storage for 30 days under high humidity conditions at 23° C. and 50% RH), is plotted on the axis of abscissa, while the number of broken test pieces (pieces/5 pieces) in the evaluation of the breakage prevention property is plotted on the axis of ordinate, and the relationship of these will be described.

From such a characteristic curve in FIG. 8, it is understood that when the lower limit of the numerical value represented by E4−E3 is 0 MPa or more, the number of broken test pieces is extremely small in the evaluation of the breakage prevention property, and satisfactory breakage prevention property is exhibited.

In contrast, it is understood that when the numerical value represented by E4−E3 has a value of less than 0 MPa, the number of broken test pieces is notably large, and sufficient breakage prevention property is not exhibited.

It has been made clear that when the numerical value represented by E4−E3 has a value of more than 8 MPa, the number of broken test pieces hardly changes; however, separately, the value of the obtained thermal shrinkage ratio is markedly decreased.

### (3) Configuration (e)

Configuration (e) is an optional configuration requirement to the effect that the lower yield point stress E3 has a value within a range of 20 to 35 MPa, and the lower yield point stress E4 has a value within a range of 20 to 35 MPa.

That is, by specifically limiting the values of the lower yield point stresses E3 and E4 in the SS curve, even when the heat-shrinkable polyester film has been stored for a long period of time under high humidity conditions, the shrink film has even less changes in the physical properties and can exhibit satisfactory and stable breakage prevention property.

Furthermore, by specifically limiting each of the values of the lower yield point stresses E3 and E4 in this way, the breakage prevention property can be controlled more accurately and stably.

Therefore, it is more preferable that the lower yield point stress E3 has a value within a range of 22 to 33 MPa, and even more preferably a value within a range of 24 to 31 MPa.

It is more preferable that the lower yield point stress E4 has a value within a range of 22 to 33 MPa, and even more preferably a value within a range of 24 to 31 MPa.

(4) Configuration (f)

Configuration (f) is an optional configuration requirement to the effect that when the thermal shrinkage ratio in the TD direction in a case where the heat-shrinkable polyester film is shrunk under the conditions of 10 seconds in hot water at 80° C. is designated as A2, the A2 has a value within a range of 15% to 60%.

That is, by specifically limiting the thermal shrinkage ratio A2 in hot water at 80° C. for 10 seconds to a predetermined range in this way, the thermal shrinkage ratio A1 can be controlled more easily, and satisfactory breakage prevention property can be obtained.

Therefore, it is more preferable that the thermal shrinkage ratio A2 has a value within a range of 20% to 55%, and even more preferably a value within a range of 25% to 50%.

### (5) Configuration (g)

Configuration (g) is an optional configuration requirement to the effect that when the thermal shrinkage ratio in the TD direction in a case where the heat-shrinkable polyester film is shrunk under the conditions of 10 seconds in hot water at 70° C. is designated as A3, the A3 has a value of 20% or less.

That is, by specifically limiting the thermal shrinkage ratio A3 in hot water at 70° C. for 10 seconds to be equal to or less than a predetermined range in this way, a stable thermal shrinkage ratio can be obtained at 80° C. to 100° C., and satisfactory breakage prevention property can be obtained.

More specifically, when the thermal shrinkage ratio A3 has a value of more than 208, it may be difficult to obtain a stable thermal shrinkage ratio at 80° C. to 100° C., and satisfactory breakage prevention property may not be obtained.

Therefore, it is more preferable that the upper limit of the thermal shrinkage ratio A3 has a value of 15% or less, and even more preferably a value of 10% or less.

However, when the thermal shrinkage ratio A3 is excessively small, the thermal shrinkage ratio is insufficient at 80° C. to 100° C., and the heat-shrinkable polyester film may not be able to follow the shape of a PET bottle having a complicated shape when wrapped around the bottle.

Therefore, it is more preferable that the lower limit of the thermal shrinkage ratio A3 has a value of 1% or more, and even more preferably a value of 3% or more.

### (6) Configuration (h)

Configuration (h) is an optional configuration requirement to the effect that b* in the chromaticity coordinates of CIE 1976 L*a*b* as measured according to JIS Z 8781-4:2013 has a value within a range of 0.15 to 0.5. That is, when the value of b* in the CIE chromaticity coordinates is less than 0.15, not only the transparency feeling of the heat-shrinkable polyester film is deteriorated, but also the blending amount of the crystalline polyester resin and the like is decreased, though relatively, and it may be difficult to adjust the hygroscopic property.

On the other hand, even when b* in the CIE chromaticity coordinates has a value of more than 0.5, not only the transparency feeling of the heat-shrinkable polyester film is deteriorated, but also the blending amount of the crystalline polyester resin and the like is excessive, though relatively, and the value of the thermal shrinkage ratio may be markedly decreased.

Therefore, it is more preferable that b* in the CIE chromaticity coordinates has a value within a range of 0.18 to 0.4, and even more preferably a value within a range of 0.2 to 0.3.

### (7) Configuration (i)

Configuration (i) is a configuration requirement related to the thickness (average thickness) of the heat-shrinkable polyester film of the first embodiment and is an optional configuration requirement to the effect that the thickness has a value usually within a range of 10 to 100 μm.

That is, by specifically limiting the thickness of the heat-shrinkable polyester film to a value within a predetermined range, even more satisfactory breakage prevention property can be obtained.

More specifically, when the thickness of the heat-shrinkable polyester film has a value of less than 10 μm, since the mechanical strength is markedly decreased, handling may be difficult, or it may be difficult to exhibit satisfactory breakage prevention property.

On the other hand, when the thickness of the heat-shrinkable polyester film has a value of more than 100 μm, it may be difficult to produce the film into a uniform thickness, or when the heat-shrinkable polyester film is thermally shrunk at a predetermined temperature, the film may not be thermally shrunk uniformly, and it may be difficult to exhibit satisfactory breakage prevention property.

Therefore, it is more preferable that the thickness of the film as the configuration (i) has a value within a range of 15 to 70 μm, and even more preferably a value within a range of 20 to 60 μm.

### (8) Configuration (j)

Configuration (j) is an optional configuration requirement to the effect that with regard to the heat-shrinkable polyester film of the first embodiment, a haze value of the film before thermal shrinkage as measured according to JIS K 7136:2000 has a value of 8% or less.

That is, by specifically limiting the haze value to a value within a predetermined range in this way, the transparency of the heat-shrinkable polyester film is also easily controlled quantitatively, and from the viewpoint of having satisfactory transparency, versatility can be further enhanced.

More specifically, it is because when the haze value of the film before thermal shrinkage has a value of more than 8%, transparency may be decreased, and it may be difficult to apply the film to decorative use and the like for a PET bottle.

On the other hand, it is because when the haze value of the film before thermal shrinkage is excessively small, it may be difficult to stably control the haze value, and the product yield in production may be markedly decreased.

Therefore, it is more preferable that the haze value of the film before thermal shrinkage as the configuration (j) has a value within a range of 0.1% to 6%, and even more preferably a value within a range of 0.5% to 5%.

### (9) Others

It is preferable that various additives are blended into the heat-shrinkable polyester film of the first embodiment or into one surface or both surfaces of the film, or those various additives are attached thereto. More specifically, it is preferable that at least one of a hydrolysis inhibitor, an antistatic agent, an ultraviolet absorber, an infrared absorber, a colorant, an organic filler, an inorganic filler, organic fibers, inorganic fibers, and the like is blended usually in an amount in a range of 0.01% to 10% by weight, and more preferably blended in an amount in a range of 0.1% to 1% by weight, with respect to the total amount of the heat-shrinkable polyester film.

As shown in FIG. 1B, it is also preferable that other resin layers 10a and 10b including at least one of these various additives are laminated on one surface or both surfaces of the heat-shrinkable polyester film 10.

In that case, when the thickness of the heat-shrinkable polyester film is taken as 100%, it is preferable that the single layer thickness or the total thickness of the other resin layers that are additionally laminated has a value usually within a range of 0.1% to 10%.

The resin as a main component constituting the other resin layers may be the same polyester resin as that of the heat-shrinkable polyester film, or it is preferable that the resin is at least one of an acrylic resin, an olefin resin, a urethane resin, a rubber resin, and the like, which are different from the polyester resin.

In addition, it is also preferable that the heat-shrinkable polyester film has a multilayer structure to further promote a hydrolysis preventing effect or mechanical protection, or as shown in FIG. 1C, a shrinkage ratio adjusting layer 10c is provided on the surface of the heat-shrinkable polyester film 10 so that the shrinkage ratio of the heat-shrinkable polyester film is uniform in the plane.

Such a shrinkage ratio adjusting layer can be laminated by using an adhesive, a coating method, a heating treatment, or the like depending on the shrinkage characteristics of the heat-shrinkable polyester film.

More specifically, the thickness of the shrinkage ratio adjusting layer is in a range of 0.1 to 3 μm, and when the shrinkage ratio of the heat-shrinkable polyester film at a predetermined temperature is excessively large, it is preferable to laminate a shrinkage ratio adjusting layer of a type that suppresses the large shrinkage ratio.

Furthermore, when the shrinkage ratio of the heat-shrinkable polyester film at a predetermined temperature is excessively small, it is preferable to laminate a shrinkage ratio adjusting layer of a type that increases the small shrinkage ratio.

Therefore, it is intended to obtain a desired shrinkage ratio by using a shrinkage ratio adjusting layer without producing various shrink films having different shrinkage ratios as the heat-shrinkable polyester film.

### Second Embodiment

A second embodiment is an embodiment related to a method for producing the heat-shrinkable polyester film of the first embodiment.

### 1. Raw Material Preparation and Mixing Step

First, it is preferable to prepare main agents and additives, such as a non-crystalline polyester resin, a crystalline polyester resin, a rubber resin, an antistatic agent, and a hydrolysis inhibitor, as raw materials.

Next, it is preferable that the prepared crystalline polyester resin, non-crystalline polyester resin, and the like are introduced into a stirring vessel while being weighed, and the raw materials are mixed and stirred using a stirring device until the mixture becomes uniform.

### 2. Original Sheet Production Step

Next, it is preferable that the uniformly mixed raw materials are dried into an absolutely dry state. Next, typically, it is preferable to perform extrusion molding and produce an original sheet before stretching (sometimes simply referred to original sheet) having a predetermined thickness.

More specifically, for example, extrusion molding is performed by using an extruder (manufactured by Tanabe Plastics Machinery Co., Ltd.) with L/D 24 and an extrusion screw diameter of 50 mm under the conditions of an extrusion temperature of 245° C., and an original sheet having a predetermined thickness (usually, 30 to 1000 μm) can be obtained.

### 3. Production of Heat-Shrinkable Polyester Film

Next, the obtained original sheet is heated and pressed while being moved on rolls and between rolls by using a shrink film production apparatus to produce a heat-shrinkable polyester film.

That is, it is preferable that polyester molecules constituting the heat-shrinkable polyester film are crystallized into a predetermined shape by stretching the original sheet in a predetermined direction while heating and pressing the film while basically extending the film width at a predetermined preliminary heating temperature, stretching temperature, thermal fixation temperature, and the stretch ratio that will be described below.

Then, by solidifying the resultant in that state, a heat-shrinkable polyester film that is used as decorations, labels, and the like can be produced.

### (1) Stretch Ratio in MD Direction

It is preferable that the stretch ratio in the MD direction (average MD direction stretch ratio, may be simply referred to as MD direction stretch ratio) of the heat-shrinkable polyester film before thermal shrinkage has a value within a range of 100% to 200%.

The reason for this is that by specifically limiting the MD direction stretch ratio to a value within a predetermined range in this way and specifically limiting each of the thermal shrinkage ratios A1 to A3, the upper yield point stresses E1 and E2, the numerical value represented by E2−E1, the lower yield point stresses E3 and E4, the numerical value represented by E4−E3, and the like to a value within a predetermined range, even when the heat-shrinkable polyester film has been stored for a long period of time under predetermined high humidity conditions, desired thermal shrinkage ratios can be obtained with satisfactory reproducibility at a predetermined temperature, and a heat-shrinkable polyester film that provides excellent breakage prevention property can be obtained.

More specifically, it is because when the MD direction stretch ratio has a value of less than 100%, the product yield in production may be markedly decreased.

On the other hand, it is because when the MD direction stretch ratio is more than 200%, the shrinkage ratio in the TD direction is affected, and adjustment of the shrinkage ratio itself may be difficult.

Therefore, it is more preferable that the MD direction stretch ratio has a value within a range of 100% to 150%, and even more preferably a value within a range of 100% to 120%.

### (2) Stretch Ratio in TD Direction

Furthermore, it is a suitable embodiment that the stretch ratio in the TD direction (average TD direction stretch ratio, may be simply referred to as TD direction stretch ratio) of the heat-shrinkable polyester film before thermal shrinkage has a value within a range of 300% to 600%.

The reason for this is that by specifically limiting not only the above-mentioned MD direction stretch ratio but also the TD direction stretch ratio to values within predetermined ranges, and specifically limiting each of the thermal shrinkage ratios A1 to A3, the upper yield point stresses E1 and E2, the numerical value represented by E2−E1, the lower yield point stresses E3 and E4, the numerical value represented by E4−E3, and the like to a value within a predetermined range, a heat-shrinkable polyester film that provides even more excellent breakage prevention property can be obtained.

More specifically, it is because when the TD direction stretch ratio has a value of less than 300%, the shrinkage ratio in the TD direction may be markedly decreased, and the use applications of the heat-shrinkable polyester film available for use may be excessively limited.

On the other hand, it is because when the TD direction stretch ratio has a value of more than 600%, the thermal shrinkage ratio may be markedly increased, and the use applications of the heat-shrinkable polyester film available for use may be excessively limited, or it may be difficult to control the stretch ratio itself to be constant.

Therefore, it is more preferable that the TD direction stretch ratio has a value within a range of 350% to 550%, and even more preferably a value within a range of 400% to 500%.

### 4. Heat-Shrinkable Polyester Film Inspection Step

It is preferable that the following characteristics and the like are measured continuously or intermittently for the produced heat-shrinkable polyester film, and a predetermined inspection step is provided.

That is, by measuring the following characteristics and the like by a predetermined inspection step and checking whether the values fall within predetermined ranges, a heat-shrinkable polyester film having more uniform shrinkage characteristics and the like can be obtained.
1) Examination by visual inspection on the appearance of the heat-shrinkable polyester film
2) Measurement of variation in thickness
3) Measurement of tensile modulus of elasticity
4) Measurement of tear strength
5) Measurement of viscoelasticity characteristics using an SS curve

For the production of the heat-shrinkable polyester film of the second embodiment, it is important to measure the following configurations (a) and (b) and check that the configurations have values within predetermined ranges.

(a) When the upper yield point stresses in a stress-strain curve in the MD direction as measured before and after storage for 30 days under high humidity conditions at 23° C. and 50% RH are designated as E1 (MPa) and E2 (MPa), respectively, the E1 and E2 satisfy the following relational expression (1):

$$0 \leq E 2 - E 1 \leq 10. \qquad ( 1 )$$

(b) When a thermal shrinkage ratio in the TD direction in a case where the heat-shrinkable polyester film is shrunk under the conditions of 10 seconds in hot water at 98° C. is designated as A1, the A1 has a value within a range of 30% to 80%.

### Third Embodiment

A third embodiment is an embodiment related to a method of using a heat-shrinkable polyester film. Therefore, that is, known methods of using shrink films can all be suitably applied.

For example, upon carrying out a method of using a heat-shrinkable polyester film, first, the heat-shrinkable polyester film is cut into an appropriate length or width, and at the same time, a long tubular-shaped object is formed.

Next, this long tubular-shaped object is supplied to an automatic label wrapping apparatus (shrink labeler) and further cut into a required length.

Next, the long tubular-shaped object is fitted onto a PET bottle filled with contents.

Next, as a heating treatment for the heat-shrinkable polyester film fitted onto a PET bottle or the like, the PET bottle or the like is passed through the inside of a hot air tunnel or a steam tunnel at a predetermined temperature.

Then, by blowing radiant heat such as infrared radiation or heated steam at about 90° C. provided in these tunnels from the surroundings, the heat-shrinkable polyester film is uniformly heated and thermally shrunk.

Therefore, a labeled container can be quickly obtained by closely attaching the heat-shrinkable polyester film to the outer surface of the PET bottle or the like.

That is, according to the heat-shrinkable polyester film of the present invention, there is provided a heat-shrinkable polyester film derived from a polyester resin composition including a crystalline polyester resin in an amount in a range of 10% to 70% by weight with respect to the total resin amount, and as the heat-shrinkable polyester film satisfies at least configurations (a) and (b), even when the heat-shrinkable polyester film is stored for a long period of time under predetermined high humidity conditions, the hygroscopic property can be controlled, and desired thermal shrinkage ratios and satisfactory breakage prevention property can be obtained with satisfactory reproducibility.

Therefore, as shown in FIG. 7A, even when the shrink film is significantly elongated, the shrink does not break, and deterioration of the breakage prevention property based on the changes in the physical properties associated with moisture absorption under high humidity conditions can be prevented.

On the other hand, when the heat-shrinkable polyester film does not satisfy at least the configurations (a) and (b), as shown in FIG. 7B, deterioration of the breakage prevention property based on the changes in the physical properties associated with moisture absorption cannot be suppressed, and the shrink film is likely to break.

### EXAMPLES

Hereinafter, the present invention will be described in detail on the basis of Examples. However, the scope of rights of the present invention is not to be limited by the description of Examples and the like, without any particular reason.

The polyester resins and the like used in the Examples and the like are as follows.

### (PETG1)

A non-crystalline polyester composed of dicarboxylic acid: 100 mol % of terephthalic acid, diol: 63 mol % of ethylene glycol, 24 mol % of 1, 4-cyclohexanedimethanol, and 13 mol % of diethylene glycol

### (PETG2)

A non-crystalline polyester composed of dicarboxylic acid: 100 mol % of terephthalic acid, diol: 59.9 mol % of ethylene glycol, 27.7 mol % of 1, 4-cyclohexanedimethanol, and 12.4 mol % of diethylene glycol

### (PETG3)

A non-crystalline polyester composed of dicarboxylic acid: 100 mol % of terephthalic acid, diol: 68 mol % of ethylene glycol, 22 mol % of 1, 4-cyclohexanedimethanol, and 10 mol % of diethylene glycol

### (APET)

A crystalline polyester composed of dicarboxylic acid: 100 mol % of terephthalic acid, diol: 100 mol % of ethylene glycol

### (PCR)

A crystalline polyester resin composed of dicarboxylic acid: 98.6 mol % of terephthalic acid, 1.4 mol % of isophthalic acid, diol: 97.3 mol % of ethylene glycol, and 2.7 mol % of diethylene glycol

### (PBT)

A crystalline polyester composed of dicarboxylic acid: 100 mol % of terephthalic acid, diol: 100 mol % of 1,4-butanediol

### (Additive (Anti-Blocking Agent))

A silica masterbatch composed of matrix resin: PET, silica content: 5% by mass, average particle size of silica: 2.7 μm

### Example 1

1. Production of Heat-Shrinkable Polyester Film 90 parts by weight (pbw) of a non-crystalline polyester resin (PETG1), 10 parts by weight of a crystalline polyester resin (A-PET), and 0.8 part by weight of a predetermined additive (anti-blocking agent) were placed in a stirring vessel.

Next, these raw materials were brought into an absolutely dry state, subsequently extrusion molding was performed by using an extruder (manufactured by Tanabe Plastics Machinery Co., Ltd.) with L/D 24 and an extrusion screw diameter of 50 mm under the conditions of an extrusion temperature of 245° C., and an original sheet having a thickness of 150 μm was obtained.

Next, a heat-shrinkable polyester film having a thickness of 30 μm was produced from the original sheet by using a shrink film production apparatus at a preliminary heating temperature of 80° C., a stretching temperature of 80° C., a thermal fixation temperature of 78° C., and stretch ratios (MD direction: 100%, TD direction: 500%).

### 2. Evaluation of Heat-Shrinkable Polyester Film

### (1) Evaluation 1: Variation in Thickness

The thickness (taking the desired value 30 μm as a reference value) of the obtained heat-shrinkable polyester film was measured by using a micrometer and was evaluated according to the following criteria as Eva 1.
⊙ (Very good): The variation in thickness is a value within a range of (reference value±0.1 μm).
◯ (Good): The variation in thickness is a value within a range of (reference value±0.5 μm).
Δ (Fair): The variation in thickness is a value within a range of (reference value±1.0 μm).
X (Bad): The variation in thickness is a value within a range of (reference value±3.0 μm).

### (2) Evaluation 2: Upper Yield Point Stresses (E1 and E2)

Before and after storage of the obtained heat-shrinkable polyester film for 30 days under high humidity conditions of 20° C. and 90% RH, the upper yield point stresses E1 (MPa) and E2 (MPa) in the SS curve in the MD direction of the film were measured.

From the obtained upper yield point stresses E1 and E2, the value of E2−E1 was calculated and used for each evaluation as Eva 2.

### (2)-1 Evaluation 2-1: Upper Yield Point Stress (E1)

The measured upper yield point stress (E1) was evaluated according to the following criteria.
⊙ (Very good): The upper yield point stress (E1) has a value within a range of 50 to 60 MPa.
◯ (Good): The upper yield point stress (E1) is outside the above-described range and has a value within a range of 45 to 65 MPa.
Δ (Fair): The upper yield point stress (E1) is outside the above-described range and has a value within a range of 40 to 70 MPa.
X (Bad): The upper yield point stress (E1) has a value of less than 40 MPa or more than 70 MPa.

### (2)-2 Evaluation 2-2: Upper Yield Point Stress (E2)

The measured upper yield point stress (E2) was evaluated according to the following criteria.
⊙ (Very good): The upper yield point stress (E2) has a value within a range of 55 to 65 MPa.
◯ (Good): The upper yield point stress (E2) is outside the above-described range and has a value within a range of 50 to 70 MPa.
Δ (Fair): The upper yield point stress (E2) is outside the above-described range and has a value within a range of 45 to 75 MPa.
X (Bad): The upper yield point stress (E2) has a value of less than 45 MPa or more than 75 MPa.

### (2)-3 Evaluation 2-3: Difference Between Upper Yield Point Stresses (E2-E1)

The calculated value of E2-E1 was evaluated according to the following criteria.
⊙ (Very good): The difference between the upper yield point stresses (E2-E1) has a value within a range of 1 to 9 MPa.
◯ (Good): The difference between the upper yield point stresses (E2-E1) is outside the above-described range and has a value within a range of 0 to 10 MPa.
Δ (Fair): The difference between the upper yield point stresses (E2-E1) is outside the above-described range and has a value within a range of −0.5 to 12 MPa.
X (Bad): The difference between the upper yield point stresses (E2-E1) has a value of less than-0.5 MPa or more than 12 MPa.

### (3) Evaluation 3: Lower Yield Point Stresses (E3 and E4)

Before and after storage of the obtained heat-shrinkable polyester film for 30 days under high humidity conditions of 20° C. and 90% RH, the lower yield point stresses E3 (MPa) and E4 (MPa) in the SS curve in the MD direction of the film were measured.

From the obtained lower yield point stresses E3 and E4, the value of E4−E3 was calculated and used for each evaluation as Eva 3.

### (3)-1 Evaluation 3-1: Lower Yield Point Stress (E3)

The measured lower yield point stress (E3) was evaluated according to the following criteria.
⊙ (Very good): The lower yield point stress (E3) has a value within a range of 22 to 33 MPa.
◯ (Good): The lower yield point stress (E3) is outside the above-described range and has a value within a range of 20 to 35 MPa.
Δ (Fair): The lower yield point stress (E3) is outside the above-described range and has a value within a range of 15 to 40 MPa.
X (Bad): The lower yield point stress (E3) has a value of less than 15 MPa or more than 40 MPa.

### (3)-2 Evaluation 3-2: Lower Yield Point Stress (E4)

The measured lower yield point stress (E4) was evaluated according to the following criteria.
⊙ (Very good): The lower yield point stress (E4) has a value within a range of 22 to 33 MPa.
◯ (Good): The lower yield point stress (E4) is outside the above-described range and has a value within a range of 20 to 35 MPa.
Δ (Fair): The lower yield point stress (E4) is outside the above-described range and has a value within a range of 15 to 40 MPa.
X (Bad): The lower yield point stress (E4) has a value of less than 15 MPa or more than 40 MPa.

### (3)-3 Evaluation 3-3: Difference Between Lower Yield Point Stresses (E4-E3)

The calculated value of E4−E3 was evaluated according to the following criteria.
⊙ (Very good): The difference between the lower yield point stresses (E4-E3) has a value within a range of 1 to 7 MPa.
◯ (Good): The difference between the lower yield point stresses (E4-E3) is outside the above-described range and has a value within a range of 0 to 8 MPa.
Δ (Fair): The difference between the lower yield point stresses (E4-E3) is outside the above-described range and has a value within a range of −0.5 to 10 MPa.
X (Bad): The difference between the lower yield point stresses (E4-E3) has a value of less than-0.5 MPa or more than 10 MPa.

### (4) Evaluation 4: Thermal Shrinkage Ratio (A1)

The obtained heat-shrinkable polyester film (TD direction) was immersed in hot water at 98° C. for 10 seconds by using a constant-temperature water bath and was thermally shrunk.

Next, the thermal shrinkage ratio (A1) was calculated according to the above-described Formula (3) from the dimensional changes occurred before and after a heating treatment at a predetermined temperature (hot water at 98° C.) and was evaluated according to the following criteria as Eva 4.

$$Thermal shrinkage ratio = \frac{\begin{matrix}( Length of film before thermal shrinkage - \\ Length of film after thermal shrinkage )\end{matrix}}{Length of film before thermal shrinkage} \times 100 \qquad ( 3 )$$

⊙ (Very good): The thermal shrinkage ratio (A1) has a value within a range of 35% to 75%.
◯ (Good): The thermal shrinkage ratio (A1) is outside the above-described range and has a value within a range of 30% to 80%.
Δ (Fair): The thermal shrinkage ratio (A1) is outside the above-described range and has a value within a range of 25% to 85%.
X (Bad): The thermal shrinkage ratio (A1) has a value of less than 25% and more than 85%.

### (5) Evaluation 5: Thermal Shrinkage Ratio (A2)

The obtained heat-shrinkable polyester film (TD direction) was immersed in hot water at 80° C. for 10 seconds by using a constant-temperature water bath and was thermally shrunk.

Next, the thermal shrinkage ratio (A2) was calculated according to the above-described Formula (3) from the dimensional changes occurred before and after a heating treatment at a predetermined temperature (hot water at 80° C.) and was evaluated according to the following criteria as Eva 5.
⊙ (Very good): The thermal shrinkage ratio (A2) has a value within a range of 20% to 55%.
◯ (Good): The thermal shrinkage ratio (A2) is outside the above-described range and has a value within a range of 15% to 60%.
Δ (Fair): The thermal shrinkage ratio (A2) is outside the above-described range and has a value within a range of 10% to 65%.
X (Bad): The thermal shrinkage ratio (A2) has a value of less than 10% and more than 65%.

### (6) Evaluation 6: Thermal Shrinkage Ratio (A3)

The obtained heat-shrinkable polyester film (TD direction) was immersed in hot water at 70° C. for 10 seconds by using a constant-temperature water bath and was thermally shrunk.

Next, the thermal shrinkage ratio (A3) was calculated according to the above-described Formula (3) from the dimensional changes occurred before and after a heating treatment at a predetermined temperature (hot water at 70° C.) and was evaluated according to the following criteria as Eva 6.
⊙ (Very good): The thermal shrinkage ratio (A3) has a value of 15% or less.
◯ (Good): The thermal shrinkage ratio (A3) has a value of 20% or less.
Δ (Fair): The thermal shrinkage ratio (A3) has a value of 25% or less.
X (Bad): The thermal shrinkage ratio (A3) has a value of more than 25%.

### (7) Evaluation 7: Breakage Prevention Property

The obtained heat-shrinkable polyester film was stored for 30 days under the conditions of a temperature of 23° C. and a relative humidity of 50% RH as an aging treatment.

Next, the film obtained after the aging treatment was cut into a strip form having a width in the MD direction of 15 mm and a length in the TD direction of 200 mm, and this strip form was used as a test piece.

Next, a tensile test was performed according to JIS K 7127:1999 using the test pieces (5 pieces) after the aging treatment as samples at a tensile speed of 200 mm/min in an atmosphere at a temperature of 23° C. and a relative humidity of 50% RH, and the number of samples broken in an elastic region in the stress-strain curve was evaluated as the breakage prevention property according to the following criteria as Eva 7.
⊙ (Very good): No breakage phenomenon was observed in all of the five test pieces.
◯ (Good): A breakage phenomenon was observed in two or fewer out of the five test pieces.
Δ (Fair): The occurrence of a breakage phenomenon was observed in three or more out of the five test pieces.
X (Bad): The occurrence of a breakage phenomenon was observed in four or more out of the five test pieces.

### (8) Evaluation 8: b* in Chromaticity Coordinates

With regard to the obtained heat-shrinkable polyester film, b* in the chromaticity coordinates of CIE 1976 L*a*b* as measured according to JIS Z 8781-4:2013 was measured by using a spectrophotometer (manufactured by SHIMADZU CORPORATION, product name “UV-3600”), and the color tinge of the shrink film was evaluated according to the following criteria.
⊙ (Very good): b* in the chromaticity coordinates has a value within a range of 0.18 to 0.4.
◯ (Good): b* in the chromaticity coordinates is outside the above-described range and has a value within a range of 0.15 to 0.5.
Δ (Fair): b* in the chromaticity coordinates is outside the above-described range and has a value within a range of 0.12 to 0.6.
X (Bad): b* in the chromaticity coordinates has a value of less than 0.12 or more than 0.6.

### Example 2

In Example 2, as shown in Table 1, 70 parts by weight of a non-crystalline polyester resin (PETG1), 30 parts by weight of a crystalline polyester resin (A-PET), and 0.8 parts by weight of a predetermined additive (anti-blocking agent) were used.

At the same time, similarly to Example 1, a heat-shrinkable polyester film having a thickness of 30 μm was produced from the original sheet at a preliminary heating temperature of 80° C., a stretching temperature of 80° C., a thermal fixation temperature of 78° C., and at stretch ratios (MD direction: 100%, TD direction: 500%).

Then, with regard to the produced heat-shrinkable polyester film, the breakage prevention property and the like were evaluated in the same manner as in Example 1.

The results are shown in Table 2.

### Example 3

In Example 3, as shown in Table 1, 50 parts by weight of a non-crystalline polyester resin (PETG1), 50 parts by weight of a crystalline polyester resin (A-PET), and 0.8 parts by weight of the predetermined additive (anti-blocking agent) were used.

At the same time, similarly to Example 1, a heat-shrinkable polyester film having a thickness of 30 μm was produced from the original sheet at a preliminary heating temperature of 80° C., a stretching temperature of 80° C., a thermal fixation temperature of 78° C., and at stretch ratios (MD direction: 100%, TD direction: 500%).

Then, with regard to the produced heat-shrinkable polyester film, the breakage prevention property and the like were evaluated in the same manner as in Example 1. The results are shown in Table 2.

### Example 4

In Example 4, as shown in Table 1, 30 parts by weight of a non-crystalline polyester resin (PETG1), 70 parts by weight of a crystalline polyester resin (A-PET), and 0.8 parts by weight of the predetermined additive (anti-blocking agent) were used.

At the same time, similarly to Example 1, a heat-shrinkable polyester film having a thickness of 30 μm was produced from the original sheet at a preliminary heating temperature of 80° C., a stretching temperature of 80° C., a thermal fixation temperature of 78° C., and at stretch ratios (MD direction: 100%, TD direction: 500%).

Then, with regard to the produced heat-shrinkable polyester film, the breakage prevention property and the like were evaluated in the same manner as in Example 1. The results are shown in Table 2.

### Example 5

In Example 5, as shown in Table 1, 70 parts by weight of a non-crystalline polyester resin (PETG2), 30 parts by weight of a crystalline polyester resin (PCR), and 0.8 parts by weight of the predetermined additive (anti-blocking agent) were used.

At the same time, similarly to Example 1, a heat-shrinkable polyester film having a thickness of 30 μm was produced from the original sheet at a preliminary heating temperature of 80° C., a stretching temperature of 81° C., a thermal fixation temperature of 78° C., and at stretch ratios (MD direction: 101%, TD direction: 500%).

Then, with regard to the produced heat-shrinkable polyester film, the breakage prevention property and the like were evaluated in the same manner as in Example 1. The results are shown in Table 2.

### Comparative Example 1

In Comparative Example 1, as shown in Table 1, a heat-shrinkable polyester film that had a low value of the configuration (a) and did not satisfy the configuration (a) was produced and evaluated in the same manner as in Example 1, and the results are shown in Table 2.

That is, 90 parts by weight of a non-crystalline polyester resin (PETG3), 10 parts by weight of a crystalline polyester resin (PBT), and 0.8 parts by weight of the predetermined additive (anti-blocking agent) were used.

At the same time, similarly to Example 1, a heat-shrinkable polyester film having a thickness of 30 μm was produced from the original sheet at a preliminary heating temperature of 90° C., a stretching temperature of 83° C., a thermal fixation temperature of 81° C., and at stretch ratios (MD direction: 101%, TD direction: 500%).

Then, with regard to the produced heat-shrinkable polyester film, the breakage prevention property and the like were evaluated in the same manner as in Example 1. The results are shown in Table 2.

### Comparative Example 2

In Comparative Example 2, as shown in Table 1, a heat-shrinkable polyester film that had no upper yield point stress E2 appearing in the chart after storage for 30 days under high humidity conditions at 23° C. and 50% RH, and did not satisfy the configuration (a), was produced, a heat-shrinkable polyester film was produced and evaluated in the same manner as in Example 1, and the results were summarized in Table 2.

That is, 100 parts by weight of a non-crystalline polyester resin (PETG3) and 0.8 parts by weight of the predetermined additive (anti-blocking agent) were used.

At the same time, similarly to Example 1, a heat-shrinkable polyester film having a thickness of 30 μm was produced from the original sheet at a preliminary heating temperature of 90° C., a stretching temperature of 83° C., a thermal fixation temperature of 81° C., and at stretch ratios (MD direction: 101%, TD direction: 500%).

Then, with regard to the produced heat-shrinkable polyester film, the breakage prevention property and the like were evaluated in the same manner as in Example 1. The results are shown in Table 2.

TABLE 1

| | | | | | | | | | | | MD | TD |
|---|---|---|---|---|---|---|---|---|---|---|---|---|
| | | | | | | | | Preliminary | | Thermal | direction | direction |
| | | | | | | | | heating | Stretching | fixation | stretch | stretch |
| | PETG1 | PETG2 | PETG3 | APET | PCR | PBT | Additive | temperature | temperature | temperature | ratio | ratio |
| | (pbw) | (pbw) | (pbw) | (pbw) | (pbw) | (pbw) | (pbw) | (° C.) | (° C.) | (° C.) | (%) | (%) |
| Example 1 | 90 | | | 10 | | | 0.8 | 80 | 80 | 78 | 100 | 500 |
| Example 2 | 70 | | | 30 | | | 0.8 | 80 | 80 | 78 | 100 | 500 |
| Example 3 | 50 | | | 50 | | | 0.8 | 80 | 80 | 78 | 100 | 500 |
| Example 4 | 30 | | | 70 | | | 0.8 | 80 | 80 | 78 | 100 | 500 |
| Example 5 | | 70 | | | 30 | | 0.8 | 80 | 81 | 78 | 101 | 500 |
| Comparative | | | 90 | | | 10 | 0.8 | 90 | 83 | 81 | 101 | 500 |
| Example 1 | | | | | | | | | | | | |
| Comparative | | | 100 | | | | 0.8 | 90 | 83 | 81 | 101 | 500 |
| Example 2 | | | | | | | | | | | | |

TABLE 2

| | | | Configuration | | | | | | | | |
|---|---|---|---|---|---|---|---|---|---|---|---|
| | (a) | (b) | (c) | | (d) | (e) | | (f) | (g) | (h) | (j) |
| | E2 − E1 | A1 | E1 | E2 | E4 − E3 | E3 | E4 | A2 | A3 | b* | Haze value |
| | (MPa) | (%) | (MPa) | (MPa) | (MPa) | (MPa) | (MPa) | (%) | (%) | (—) | (%) |
| Example 1 | 5.2 | 70 | 50.7 | 55.9 | 0.3 | 24.3 | 24.6 | 47 | 15 | 0.17 | 4.1 |
| Example 2 | 3.7 | 51 | 53.4 | 57.1 | 0.8 | 26.7 | 27.5 | 35 | 3 | 0.21 | 4.6 |
| Example 3 | 4.5 | 32 | 59 | 63.5 | 3.1 | 27.9 | 31 | 18 | 1 | 0.25 | 5.3 |
| Example 4 | 8.1 | 51 | 57.1 | 65.2 | 0.6 | 28.6 | 29.2 | 38 | 0 | 0.40 | 4.5 |
| Example 5 | 2.7 | 72 | 49.9 | 52.6 | 0.4 | 29.5 | 29.9 | 50 | 12 | 0.23 | 4.6 |
| Comparative | −0.6 | 75 | 53.6 | 53 | −1.6 | 28.7 | 27.1 | 52 | 27 | 0.13 | 3.5 |
| Example 1 | | | | | | | | | | | |
| Comparative | — | 73 | 49.4 | — | — | 28.3 | — | 50 | 22 | 0.10 | 3.6 |
| Example 2 | | | | | | | | | | | |

| | | Eva 2 | | | Eva 3 | | | | | | | |
|---|---|---|---|---|---|---|---|---|---|---|---|---|
| | Eva 1 | 2-1 | 2-2 | 2-3 | 3-1 | 3-2 | 3-3 | Eva 4 | Eva 5 | Eva 6 | Eva 7 | Eva 8 |
| Example 1 | ⊙ | ⊙ | ⊙ | ⊙ | ⊙ | ⊙ | ◯ | ⊙ | ⊙ | ⊙ | ◯ | ◯ |
| Example 2 | ⊙ | ⊙ | ⊙ | ⊙ | ⊙ | ⊙ | ◯ | ⊙ | ⊙ | ⊙ | ◯ | ⊙ |
| Example 3 | ⊙ | ⊙ | ⊙ | ⊙ | ⊙ | ⊙ | ⊙ | ◯ | ◯ | ⊙ | ⊙ | ⊙ |
| Example 4 | ⊙ | ⊙ | ◯ | ⊙ | ⊙ | ⊙ | ◯ | ⊙ | ⊙ | ⊙ | ◯ | ⊙ |
| Example 5 | ⊙ | ◯ | ◯ | ⊙ | ⊙ | ⊙ | ◯ | ⊙ | ⊙ | ⊙ | ⊙ | ⊙ |
| Comparative | ⊙ | ⊙ | ◯ | X | ⊙ | ⊙ | X | ⊙ | ⊙ | X | X | Δ |
| Example 1 | | | | | | | | | | | | |
| Comparative | ⊙ | ◯ | — | — | ⊙ | — | — | ⊙ | ⊙ | Δ | X | X |
| Example 2 | | | | | | | | | | | | |

*Eva 1: Variation in thickness
*Eva 2: Upper yield point stress
*Eva 3: Lower yield point stress
*Eva 4 to 6: Thermal shrinkage ratios A1 to A3
*Eva 7: Breakage prevention property
*Eva 8: Value of b* in chromaticity coordinates

### INDUSTRIAL APPLICABILITY

According to the present invention, a heat-shrinkable polyester film derived from a polyester resin composition including a crystalline polyester resin in an amount in a range of 10% to 70% by weight with respect to the total resin amount, the heat-shrinkable polyester film having excellent breakage prevention property even in a case where the film has been stored for 30 days under high humidity conditions at 23° C. and 50% RH as aging by satisfying at least configurations (a) and (b), can be effectively provided.

Therefore, according to the heat-shrinkable polyester film of the present invention, since versatility can be remarkably enhanced by suitably applying the heat-shrinkable polyester film to various PET bottles, outer covering materials for lunch boxes and the like, it can be said that the industrial applicability of the heat-shrinkable polyester film is very high.

1. A heat-shrinkable polyester film derived from a polyester resin composition including a crystalline polyester resin in an amount in a range of 10% to 70% by weight with respect to the total resin amount,
wherein a main shrinkage direction is designated as TD direction, a direction orthogonally intersecting the TD direction is designated as MD direction, and the heat-shrinkable polyester film satisfies the following configurations (a) and (b):
(a) when upper yield point stresses in a stress-strain curve in the MD direction as measured before and after storage for 30 days under high humidity conditions at 23° C. and 50% RH are designated as E1 (MPa) and E2 (MPa), respectively, the E1 and E2 satisfy the following relational expression (1):
$$0 \leq E 2 - E 1 \leq 10 ; \qquad ( 1 )$$
(b) when a thermal shrinkage ratio in the TD direction in a case where the heat-shrinkable polyester film is shrunk under the conditions of 10 seconds in hot water at 98° C. is designated as A1, the A1 has a value within a range of 30% to 80%.

2. The heat-shrinkable polyester film according to claim 1, wherein as configuration (c), the upper yield point stress E1 has a value within a range of 45 to 65 MPa, and the upper yield point stress E2 has a value within a range of 50 to 70 MPa.

3. The heat-shrinkable polyester film according to claim 1, wherein as configuration (d), when lower yield point stresses in a stress-strain curve in the MD direction as measured before and after storage for 30 days under high humidity conditions at 23° C. and 50% RH are designated as E3 (MPa) and E4 (MPa), respectively, the E3 and E4 satisfy the following relational expression (2):
$$0 \leq E 4 - E 3 \leq 8 . \qquad ( 2 )$$

4. The heat-shrinkable polyester film according to claim 3, wherein as configuration (e), the lower yield point stress E3 has a value within a range of 20 to 35 MPa, and the lower yield point stress E4 has a value within a range of 20 to 35 MPa.

5. The heat-shrinkable polyester film according to claim 1, wherein as configuration (f), when a thermal shrinkage ratio in the TD direction in a case where the heat-shrinkable polyester film is shrunk under the conditions of 10 seconds in hot water at 80° C. is designated as A2, the A2 has a value within a range of 15% to 60%.

6. The heat-shrinkable polyester film according to claim 1, wherein as configuration (g), when a thermal shrinkage ratio in the TD direction in a case where the heat-shrinkable polyester film is shrunk under the conditions of 10 seconds in hot water at 70° C. is designated as A3, the A3 has a value of 20% or less.

7. The heat-shrinkable polyester film according to claim 1, wherein as configuration (h), b* in the chromaticity coordinates of CIE 1976 L*a*b* as measured according to JIS Z 8781-4:2013 has a value within a range of 0.15 to 0.5.

8. The heat-shrinkable polyester film according to claim 1, wherein as configuration (j), a haze value of the film before thermal shrinkage as measured according to JIS K 7136:2000 has a value of 8% or less.
